(19) United States
(12) Patent Application Publication
(10) Pub. No.: US 2006/0061516 A1
(43) Pub. Date: Mar. 23, 2006

(54) Connecting multiple monitors to a computer system

(76) Inventors: Robert G. Campbell, Cupertino, CA (US); Wesley H. Stelter, San Bruno, CA (US); Larry Shintaku, Union City, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/948,607

(22) Filed: Sep. 23, 2004

(51) Int. Cl. G09G 5/00

(52) U.S. Cl. 345/1.1

(57) ABSTRACT

Techniques are provided for connecting multiple monitors to a computer system. In an embodiment, N monitors are connected in a daisy-chain manner and constitute a virtual monitor, which the computer system considers as the only monitor in the system. The last monitor, e.g., the Nth monitor reports its display capability to the (N−1)th monitor, which aggregates its capability and the capability of the Nth monitor to the (N−2)th monitor. The (N−2)th monitor aggregates its capability and the capability of the (N−1)th and Nth monitor to the (N−3)th monitor, etc., until the first monitor in the chain aggregates the capability of all monitors in the chain, and reports this Total Capability of the virtual monitor to the computer system. When displaying information, the computer system provides the display information to the first monitor, which displays what it is responsible for, and passes on the rest of the information to the second monitor. The second monitor displays what it is responsible for, and passes the rest of the information to the third monitor, and so on, until the last monitor in the chain displays its information.

### FIELD OF THE INVENTION

The present invention relates generally to connecting multiple monitors to a computer system.

### BACKGROUND OF THE INVENTION

FIG. 1 shows an example of a computer system 100 that supports a single-monitor and includes a graphic adapter 110 connecting to a monitor 120. Adapter 110 is either embedded or plugged into a card, e.g., a motherboard (not shown).

Different approaches have allowed multiple monitors to be connected to a computer system, e.g., system 100. FIG. 2 shows a system 200 with two monitors 220(1) and 220(2). However, each monitor 220 requires a graphic adapter, e.g., adapters 210(1) and 210(2) for monitors 220(1) and 220(2), respectively. Further, in many situations, adapters 210 mismatch in capabilities including resolution, color depth, etc. For example, an adapter, e.g., adapter 210(1) is less advanced than the other adapter, e.g., adapter 210(2). This may be because, for another example, adapter 210(2) was updated to system 200 after adapter 210(1) had been installed in system 200. As a result, performance mismatch occurs in the two monitors 220(1) and 220(2). In various Windows applications, a more advanced adapter 210(2) may be limited to the capability of the less advanced adapter 210(1). That is, for system 200 to function properly, the resolution of the more advanced adapter 210(2) must be adjusted to the resolution of the less-advanced adapter 210(1). Further, if adapters 210 are made by different manufacturers, system 200 may encounter various other compatibility issues, including, for example, each adapter 210 may require a different driver; different drivers cause conflicts to one another, etc.

FIG. 3 shows a computer system 300 supporting two monitors 320(1) and 320(2) via a dual-head graphic adapter 310 having two ports 340(1) and 340(2) connecting to two monitors 320(1) and 320(2), respectively. The dual-head adapter 310 can resolve compatibility issues in systems 200, but encounter other deficiencies. For example, an owner of system 100, to upgrade to system 300, must replace adapter 110 with adapter 310. In many situations, adapter 110 is not replaceable because it is built in a motherboard of system 100/300. Further, adapter 110, being hard built in the motherboard, cannot be disabled so that adapter 310 may be enabled. Additionally, current dual-head graphic adapters like adapter 310 do not treat ports 340(1) and 340(2) as interchangeable. For example, in overlay situations, the overlay capability is generally associated with and/or default to a particular port, e.g., port 340(1), resulting in deficiencies for overlay capability in the other port, e.g., port 340(2). In any event, system 300 still considers that it is supporting two monitors, and, in many situations, encounters problems of a two-monitor system.

### SUMMARY OF THE INVENTION

The present invention, through various embodiments, provides techniques for connecting multiple monitors to a computer system. In an embodiment, N monitors are connected in a daisy-chain manner and constitute a virtual monitor, which the computer system considers as the only monitor in the system. The capability of the virtual monitor is the aggregated capability of the N monitors. The last monitor, e.g., the Nth monitor reports its display capability to the (N−1)th monitor, which aggregates its capability and the capability of the Nth monitor to the (N−2)th monitor. The (N−2)th monitor aggregates its capability and the capability of the (N−1)th and Nth monitor to the (N−3)th monitor, etc., until the first monitor in the chain aggregates the capability of all monitors in the chain, and reports this Total Capability of the virtual monitor to the computer system.

When displaying information, the computer system, via its graphic adapter, provides the display information from the frame buffer to the first monitor, which displays what it is responsible for, and passes on the rest of the information to the second monitor. The second monitor displays what it is responsible for, and passes the rest of the information to the third monitor, and so on, until the last monitor in the chain displays its information.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 shows an example of a computer system supporting a single monitor;

FIG. 2 shows a computer system with two graphic adapters to support two monitors;

FIG. 3 shows a computer system with a dual-head graphic adapter to support two monitors;

FIG. 4 shows a computer system with a chain of monitors in accordance with an embodiment of the invention;

FIG. 5 shows a computer system supporting K chains of monitors expanded horizontally, and each chain includes L number of monitors, in accordance with an embodiment of the invention;

FIG. 6 shows a computer system supporting L chains of monitors expanded vertically, and each vertical chain includes K number of monitors, in accordance with an embodiment of the invention;

FIG. 7 shows a graphic logic in accordance with an embodiment of the invention; and

FIG. 8 shows in detail a computer system, in accordance with an embodiment of the invention.

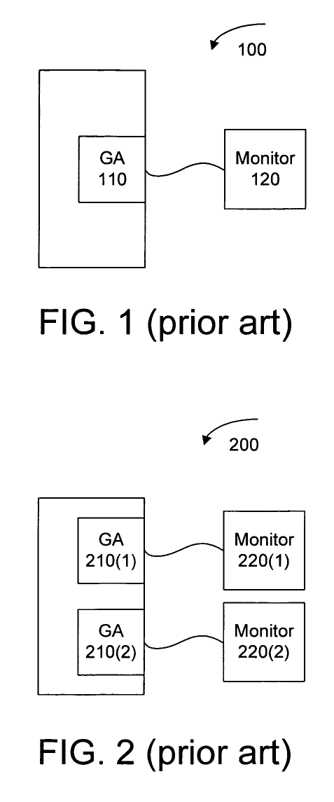

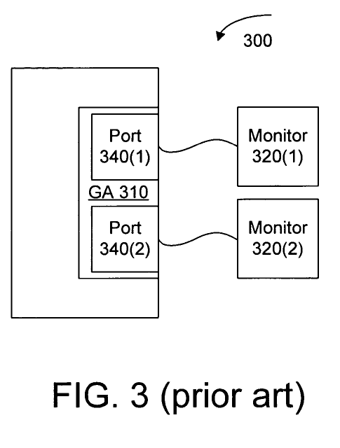

### DETAILED DESCRIPTION OF VARIOUS EMBODIMENTS

In the following description, for the purposes of explanation, numerous specific details are set forth in order to provide a thorough understanding of the present invention. However, it will be apparent to one skilled in the art that the invention may be practiced without these specific details. In other instances, well-known structures and devices are shown in block diagram form in order to avoid obscuring the invention.

### Overview

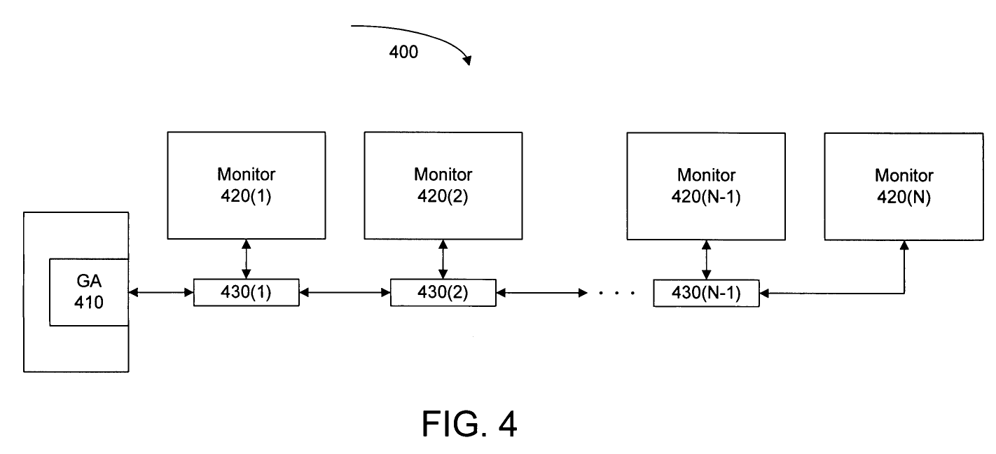

FIG. 4 shows a computer system 400 supporting multiple, e.g., N, monitors, in accordance with an embodiment of the invention. System 400 includes a graphic adapter 410 and a plurality of monitors 420(1) to 420(N). Each monitor 420, except the last monitor, e.g., monitor 420(N), is associated with a graphic logic 430. Monitors 420, via their corresponding graphic logic 430 and GA 410, are connected, to system 400, in a daisy chain manner. Graphic adapter 410 interfaces with graphic logic 430(1), while graphic logic 430(1) interfaces with graphic logic 430(2); graphic logic 430(2) interfaces with graphic logic 430(3), and so on, until graphic logic 430(N−2) interfaces with graphic logic 430(N−1). Each graphic logic 430 also interfaces with, and thus controls, its corresponding monitor 420.

In embodiments of the invention, graphic adapter 410 does not need to know the number of monitors included in system 400. In fact, from the operating system's and/or system 400's point of view, there is only one monitor in system 400, and, which, for illustration purposes, may be referred to as a “virtual monitor.” Further, also for illustration purposes, monitors 420(1), 420(2), . . . , and 420(N) support resolutions H(1)×V(1), H(2)×V(2), . . . , and H(N)×V(N), respectively, wherein H and V represent the respective horizontal and vertical resolutions. The capability of the virtual monitor is the aggregated capability of monitors 420(1) to 420(N), and, also for illustration purposes, this capability is referred to as the “Total Capability.”

Information to be displayed on each monitor 420 is based on the provided information for the virtual monitor and the topology of the virtual monitors. For example, once the display resolution is adjusted to the settings that can be displayed for the virtual monitor, GA 410 sends the graphic information to be displayed. Subsequently, the N monitors constituting the virtual monitor display their portions as appropriate and pass the information to the next monitor 420 in the chain of monitors 420. For example, the first monitor, e.g., monitor 420(1), via its corresponding graphic logic 430(1), displays the portion it is responsible for and passes on the rest of the information to the second monitor, e.g., monitor 420(2). The second monitor 420(2), via its corresponding graphic 430(2), displays the portion it is responsible for, and passes on the rest of the information to the third monitor, e.g., monitor 420(3), and so on until the last monitor, e.g., monitor, 420(N) displays its portion. Generally, a monitor, e.g., monitor 420(I) receives display information from graphic logic 430(I−1), and, via the monitor's intelligence, displays the information as appropriate.

To report information to GA 410, graphic logic 430(N−1) reports information to graphic logic 430(N−2); graphic logic 430(N−2) reports information to graphic logic 430(N−3); and so on, until graphic logic 430(1) reports information to GA 410. Information reported from a graphic logic 430 includes its support capabilities and aggregated information of previous graphic logics and monitors. For example, graphic logic 430(N−1) reports capability of monitors 420(N−1) and 420(N) to graphic logic 430(N−2); graphic logic 430(N−2) reports the capability of monitors 420(N−2), 430(N−1) and 430(N) to graphic logic 430(N−3); graphic logic 430(N−3) reports the capability of monitors 420(N−3), 420(N−2), 420(N−1), and 420(N) to graphic logic 430(N−4), and so on, until graphic logic 430(1) reports the aggregated or Total Capability of monitors 420(1) to 420(N), to GA 410. Each graphic logic 430 also calculates its support capability that comprises the capability of the graphic logic's corresponding monitor and monitors in the chain as appropriate. The support capability of a graphic logic 430 and/or a monitor 420 includes color depth, resolution, refresh rates, etc. GA 410 then reports to the operating system/system 400 that GA 410 supports a monitor with the Total Capability, and system 400 acts accordingly.

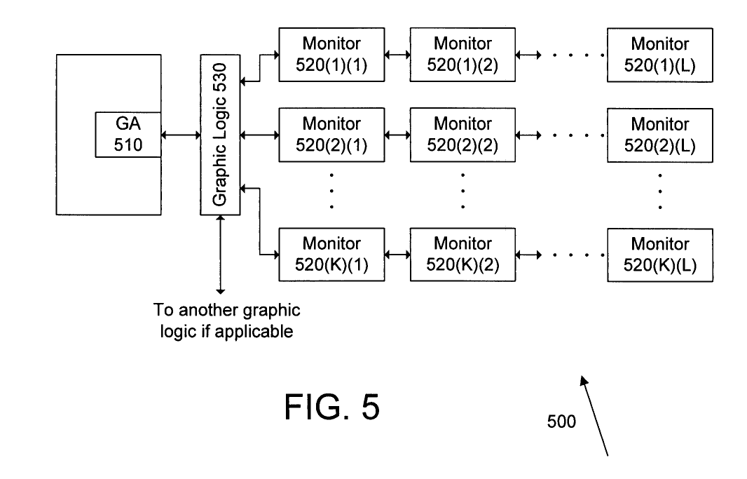

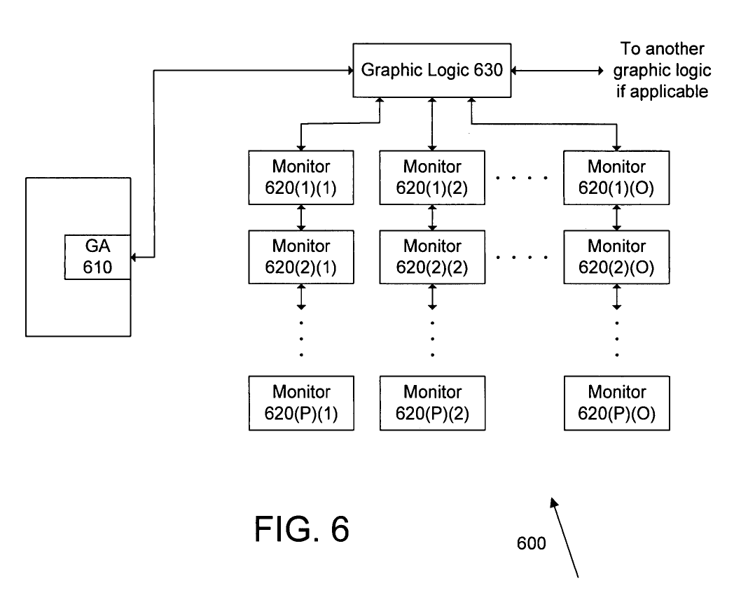

A monitor 420, when being connected to a chain of monitors 420, may require that the resolution for the virtual monitor be extended horizontally, vertically, and/or both vertically and horizontally from the first monitor in the chain, e.g., monitor 420(1). Both vertical and horizontal resolutions for different monitors 420 do not have to be the same. Common resolutions for a monitor 420 include 1600×1280, 1280×1280, 1280×1024, 1204×768, etc. Further, in place of a monitor 420, a plurality of monitors 420 may be used. For example, in FIG. 5, a graphic logic 530 is used to connect K chains of monitors, and for each horizontal chain, there are L monitors. Consequently, the total resolution for a virtual monitor constituting the L monitors is the aggregated resolution of L monitors, and when display, the total resolution is divided among the L monitors. As shown in FIG. 5, graphic logic 530 may interface with another graphic logic, which may support one and/or a plurality of monitors, one and/or a plurality of chains of monitors. Similarly, in FIG. 6, a graphic logic 630 is used to connect O chains of monitors, and for each vertical chain, there are P monitors. Further, graphic logic 630 may interface with another graphic logic, which may support one and/or a plurality of monitors, one and/or a plurality of chains of monitors. In another word, a graphic logic may be implemented to support a matrix of I×J monitors in which different and/or the same resolution for vertical and/or horizontal directions may be used.

In embodiments of the invention, the monitors can be any technology, such as LCD (Liquid Crystal Display), CRT (Cathode-Ray Tube), Plasma, projectors, etc. Connections between the graphic adapter and the monitors and between the graphic logics can also be any technology, including, for example, analog VGA, DVI (Digital Visual Interface), HDCP (High-bandwidth Digital-Content Protection), LVD (Low Voltage Differential Signaling), etc. The invention is not limited to a particular technology.

In FIG. 400, graphic logics 430 are shown external to monitors 420, but they may be internal to monitors 420. Embodiments of the invention are not limited to the location of graphic logics 430. Further, in FIG. 400, graphic logics 430 are shown as supporting two monitors, but they may support more than two monitors, and embodiments of the invention are not limited to the number of monitors a graphic logic 430 supports. In an exemplary implementation, a graphic logic, e.g., graphic logic 430(I) that supports, e.g., M monitors, may include M graphic logic 430 shown in FIG. 4. Embodiments of the invention are not limited by the number of graphic logics 430 included in system 400, either. As a result, in a system, there may be one or a plurality of graphic logics 430, and each graphic logic 430 may support one or a plurality of monitors 420, and each monitor 420 may be of the same or different resolution in both horizontal or vertical direction. A graphic logic 430 together with its corresponding monitor(s) may be referred to as a monitor node.

### Example of How Information is Displayed

The following illustrates, in accordance with an embodiment, how information is displayed for a virtual monitor comprising monitors 420(1) to 420(N) once information for this virtual monitor is provided, e.g., from GA 410. For illustration purposes, each monitor 420 is to display 1280H×1024V pixels of information, and the total information for the virtual monitor is aggregated as (1280×N)×1024 pixels of information. Alternatively speaking, (1280×N) H×1024V of pixels is to be displayed among the N monitors. Because each monitor includes a resolution of 1280H×1024V, each monitor is to display 1280 columns and 1024 rows of information. Initially, the first row of every monitor 420 is displayed, each with 1280 pixels. That is, monitor 420(1) displays the first 1280 pixels; monitor 420(2) displays the next 1280 pixels; monitor 430(2) displays the next 1280 pixels, and so on until monitor 420(N) displays the Nth 1280 pixels. Next, the second row of every monitor is displayed, each monitor with another 1280 pixels, and so on until the 1024^{th} row in which every monitor is displayed with 1280 pixels. In the case that the virtual monitor is vertically aggregated, the virtual monitor is provided with information for 1280×(1024×N) pixels to be displayed among the N monitors appropriate. Further, in the case of a combination of vertical and horizontal aggregation, the information is displayed accordingly.

### The Graphic Logic

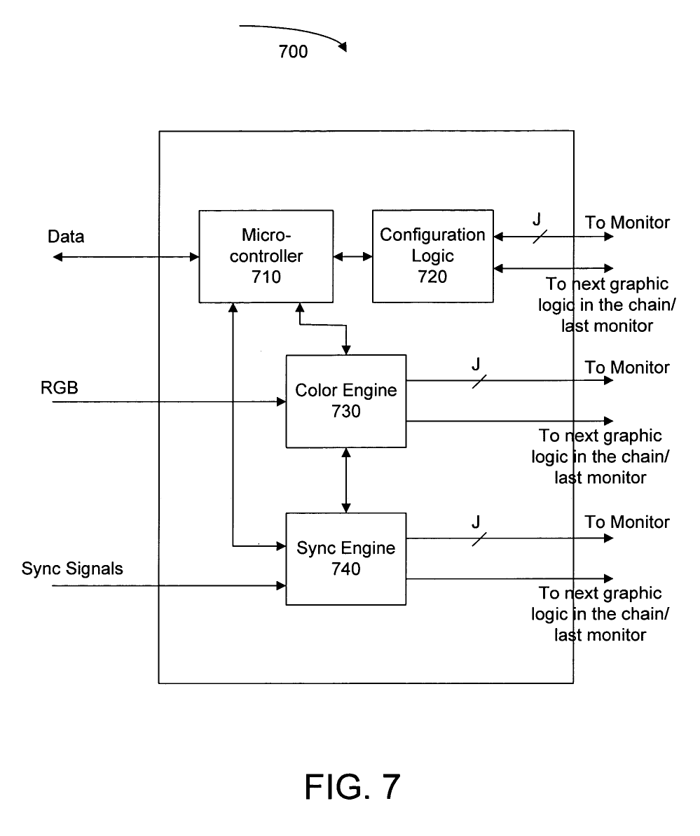

FIG. 7 shows a graphic logic 700 being an embodiment of graphic logic 430, 530, 630, etc. Graphic logic 700 includes a micro controller 710, a configuration logic 720, a color engine 730, and a sync engine 740.

Inputs to graphic logic 700 are from GA 410 if graphic logic 700 is implemented as the first graphic logic in the chain, e.g., graphic logic 430(1), and thus corresponds to monitor 420(1). However, inputs to graphic logic 700 are from another graphic logic if graphic logic 700 is implemented as another graphic logic and corresponds to a monitor other than monitor 420(1). For example, if graphic logic 700 is implemented as graphic logic 430(2) and thus corresponds to monitor 420(2), then inputs to graphic logic 700 are from graphic logic 420(1). For illustration purposes, graphic logic 700 is implemented as graphic logic 430(1), and inputs to graphic logic 700 are therefore from graphic adapter 410. Further, because graphic logic 430(1) is used in the example, explanations are discussed according to that example. However, the inventive concept is applicable and thus modified accordingly when graphic logic 700 is implemented as a graphic logic other than graphic logic 430(1).

Outputs of graphic logic 700 are provided to the corresponding monitor(s) associated with that graphic logic and another graphic logic in the chain of graphic logics. As discussed above, a graphic logic may support more than one, e.g., J number of monitors, then outputs of graphic logic 700 are provided to those J monitors. However, in the embodiment that the last monitor in the chain, e.g., monitor 420(N), that is not associated with a graphic logic 430, then, if graphic logic 700 is implemented as graphic logic 430(N−1), then outputs of graphic logic 700 that are supposed to be provided to a graphic logic in the chain are provided to monitor 420(N), e.g., the last monitor in the chain of monitors.

Micro-controller 710 serves as the central intelligence for graphic logic 700. Micro-controller 710 sets up the configuration logic, runs software, firmware, etc. Micro-controller 710 controls the amount of information to be displayed on its associated monitor(s), and passes on the rest of the information to another graphic logic 430 in the chain of graphic logics as appropriate. Micro-controller 710 calculates the aggregated capability of other graphic logics 430 and reports information to GA 410 if applicable. Micro-controller 710 also controls the timing, e.g., Hsync and Vsync, in sync engine 740, and the timing for displaying the RGB in color engine 730. For example, based on information received from configuration logic 720, color engine 730, and sync engine 740, micro-controller 710 directs color engine 730 when and how to provide the RGB to the respective monitors. Generally, the timing for the RGB results from the configuration information received from configuration logic 720. Micro-controller 710 also directs sync engine 740 on how to adjust the Hsync and Vsync signals from the signals received from GA 410. In an embodiment, micro-controller 710 includes a CPU (central processing unit), RAM (Random Access Memory), and ROM (Read-Only Memory) with corresponding software and firmware to provide the desired functions. Various logics that include components functioning as a controller are within the scope of embodiments of the invention.

Configuration logic 720, working with micro-controller 710, gathers monitor information, decides on the topology of the virtual monitor, e.g., how monitors are connected to constitute that virtual monitor. The topology of the virtual monitor may be such that all monitors, e.g., monitors 420 in system 400, are considered expanded from the first monitor in the horizontal, vertical, a combination of horizontal and vertical direction, etc. Generally, configuration logic 720 reads the capabilities of the monitors, reads configuration setting for both vertical and horizontal directions for each monitor, calculates the aggregated information, reports the aggregated information, etc. In an embodiment, configuration logic 720 communicates to the monitor industry standard Display Data Channel (DDC) for monitor communication when GA 410 requests graphic information. DDC is a VESA (Video Electronics Standards Association) standard for communication between a monitor and a video adapter. Using DDC, a monitor informs the video card, e.g., GA 410, of the monitor's properties, such as resolution, color depth, refresh rate, etc. The video card, in response, uses the information to ensure that the user is presented with valid options for configuring the display.

Generally, software running on system 400 allows the user to set up the desired resolution, such as selecting the choices from the display. Configuration logic 720 reads the monitor's capability, the setting for horizontal and vertical resolutions, reports the information including frame buffer information. Frame buffer is a memory region in a graphic adapter, e.g., GA 410, that represents displaying information on the screen of the monitor, such as the color, the pixels, etc. GA 410 reformats the frame buffer, e.g., with a plug-and play event, and thus adapts to the appropriate setup. Usually, there is a series of communications between configuration logic 720/micro-controller 710 and the monitors to understand the capabilities of the monitors, the topology, the aggregate size/resolution, etc.

Color engine 730 is responsible for colors of the monitors, e.g., monitors 420, including the RGB (Read, Green, Blue) components. Receiving the RGB from GA 410, color engine 730 routes this received RGB to the appropriate monitors, based on the topology of the virtual monitor. For example, if there are two monitors, e.g., N=2 in system 400 and the information is expanded horizontally from monitor 420(1), then color engine 730, receiving the RGB for a line from GA 410, provides the RGB, as R1 G1 and B1, to monitor 420(1) for the first half of the pixel stream, and, halfway through the information, color engine 730 provides the RGB, as R2 G2 and B2, to monitor 420(2), etc.

Sync engine 740 includes the Hsync and Vsync signals for synchronization of horizontal and vertical information, respectively. Configuration logic 720, as it reports back information to GA 410, recognizing the number of monitors included in the system and capability of the monitors, uses that information to provide the timing control information into the Hsync and Vsync.

Hsync and Vsync are timing pulses indicating to a monitor when to finish displaying information horizontally and vertically, respectively. Hsync directs the control back to the beginning of the next line once a line display is complete, and Vsync signals that information is at the bottom of a monitor, and information should be displayed at the top to start displaying the next set of pixels. Hsync and Vsync may be the same and/or modified from Hsync and Vsync from the graphic adapter, depending on the topology of the monitors constituting the virtual monitor. Sync engine 740, knowing the topology, modifies the Hsync and Vsync signals as appropriate. In general, Sync engine 740 learns of the configuration of the monitors, decides how to deploy the sync signals, e.g., considering both the horizontal and vertical resolution, and reports the aggregated resolution to the graphic adapter, etc. In response, the graphic adapter recognizes that it's dealing with a monitor of the aggregated resolution, i.e., dealing with the virtual monitor, the graphic adapter then considers the virtual monitor's configuration, formats the frame buffer, displays the information in conjunction with color engine 730. Micro-controller 710, based on the provided information, programs the timing logic with appropriate pixels to appropriate monitors. In the example that N monitors are expanding horizontally, e.g., in the example of a frame buffer with (1280×N)×1024 pixels is to be displayed to N monitors horizontally, since the vertical resolution is not modified, the Vsync is not modified. That is, this Vsync signal to graphic logic 700 is the same as the Vsync signal received from the graphic adapter. Similarly, if the monitors are expanding vertically, then the Hsync signal is unmodified from the Hsync signal received from GA 410. This is because the same number of pixels is displayed horizontally as in the case of one monitor.

For example, if the virtual monitor includes a total resolution of 2560H and 1024V to be distributed horizontally to two monitors 420(1) and 420 (2) with 1280H×1024V of pixels each, then the Hsync from GA 410 is associated with two horizontal lines, one for monitor 420(1) and one for monitor 420(2), and is therefore modified accordingly. That is, the Hsync from GA 410 is modified such that, for every line, after the first 1280 pixels are displayed on monitor 420(1), the second 1280 pixels are displayed on monitor 420(2). However, the Vsync is unchanged from the Vsync from GA 410. Similarly, if there are two monitors in system 400, but they are expanded vertically, then the Hsync from GA 410 remains unchanged while the Vsync is modified from the Vsync from GA 410.

### Exemplary Applications

For illustration purposes, there are two monitors, i.e., N=2, in system 400. Further a user initially owns the system having one monitor, e.g., monitor Old. To up grade to system 400 having two monitors, the user would buy a new monitor, e.g., monitor New, having an internal graphic logic 430(1). The user then connects monitor New as monitor 420(1) and monitor Old as monitor 420(2) in system 400. Alternatively, the buyer may buy the monitor New without an internal graphic logic, but buy this graphic logic separately, i.e., external to monitor New.

Embodiments of the invention are advantageous over other approaches because in view of the graphic adapter and/or the computer system, there is only one monitor, e.g., the virtual monitor, in the system. The graphic adapter and/or the system does not need to know the number of monitors included in the system or the differences between the different monitors. The hardware considers applications using the virtual monitor as one monitor with overlay information in frame buffer one. As a result, the overlay problem in other approaches using two monitors does not exist using embodiments of the invention.

### Computer System Overview

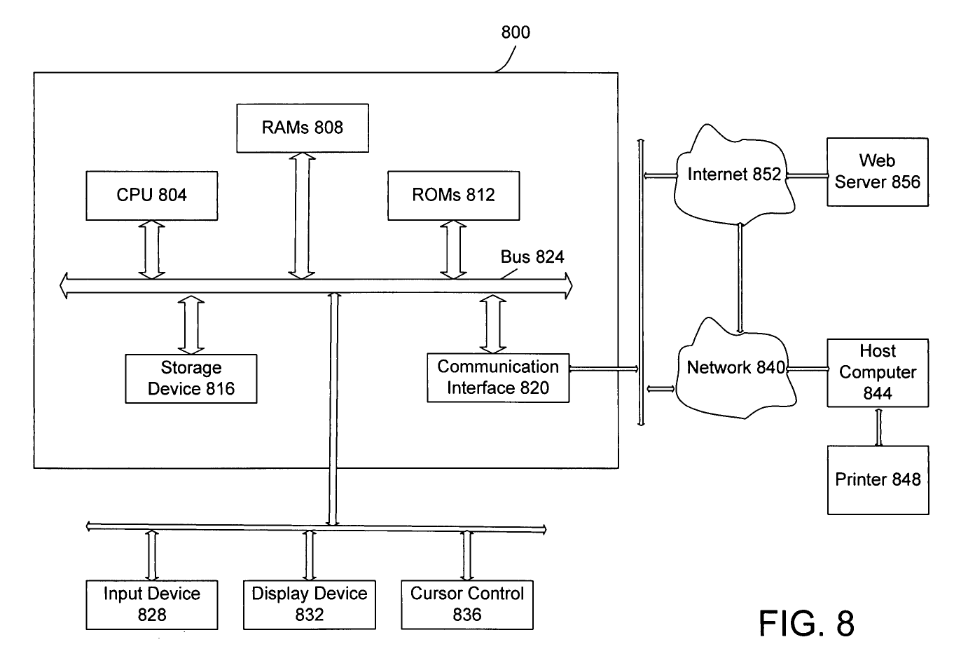

FIG. 8 is a block diagram showing a computer system 800 upon which an embodiment of the invention may be implemented. For example, computer system 800 may be implemented as system 400, 500, 600, etc., to perform functions in accordance with the techniques described above, etc. In an embodiment, computer system 800 includes a central processing unit (CPU) 804, random access memories (RAMs) 808, read-only memories (ROMs) 812, a storage device 816, and a communication interface 820, all of which are connected to a bus 824.

CPU 804 controls logic, processes information, and coordinates activities within computer system 800. In an embodiment, CPU 804 executes instructions stored in RAMs 808 and ROMs 812, by, for example, coordinating the movement of data from input device 828 to display device 832. CPU 804 may include one or a plurality of processors.

RAMs 808, usually being referred to as main memory, temporarily store information and instructions to be executed by CPU 804. Information in RAMs 808 may be obtained from input device 828 or generated by CPU 804 as part of the algorithmic processes required by the instructions that are executed by CPU 804.

ROMs 812 store information and instructions that, once written in a ROM chip, are read-only and are not modified or removed. In an embodiment, ROMs 812 store commands for configurations and initial operations of computer system 800.

Storage device 816, such as floppy disks, disk drives, or tape drives, durably stores information for use by computer system 800.

Communication interface 820 enables computer system 800 to interface with other computers or devices. Communication interface 820 may be, for example, a modem, an integrated services digital network (ISDN) card, a local area network (LAN) port, etc. Those skilled in the art will recognize that modems or ISDN cards provide data communications via telephone lines while a LAN port provides data communications via a LAN. Communication interface 820 may also allow wireless communications.

Bus 824 can be any communication mechanism for communicating information for use by computer system 800. In the example of FIG. 8, bus 824 is a media for transferring data between CPU 804, RAMs 808, ROMs 812, storage device 816, communication interface 820, etc.

Computer system 800 is typically coupled to an input device 828, a display device 832, and a cursor control 836. Input device 828, such as a keyboard including alphanumeric and other keys, communicates information and commands to CPU 804. Display device 832, such as a cathode ray tube (CRT), displays information to users of computer system 800. Cursor control 836, such as a mouse, a trackball, or cursor direction keys, communicates direction information and commands to CPU 804 and controls cursor movement on display device 832.

Computer system 800 may communicate with other computers or devices through one or more networks. For example, computer system 800, using communication interface 820, communicates through a network 840 to another computer 844 connected to a printer 848, or through the world wide web 852 to a server 856. The world wide web 852 is commonly referred to as the “Internet.” Alternatively, computer system 800 may access the Internet 852 via network 840.

Computer system 800 may be used to implement the techniques described above. In various embodiments, CPU 804 performs the steps of the techniques by executing instructions brought to RAMs 808. In alternative embodiments, hard-wired circuitry may be used in place of or in combination with software instructions to implement the described techniques. Consequently, embodiments of the invention are not limited to any one or a combination of software, firmware, hardware, or circuitry.

Instructions executed by CPU 804 may be stored in and/or carried through one or more computer-readable media, which refer to any medium from which a computer reads information. Computer-readable media may be, for example, a floppy disk, a hard disk, a zip-drive cartridge, a magnetic tape, or any other magnetic medium, a CD-ROM, a CD-RAM, a DVD-ROM, a DVD-RAM, or any other optical medium, paper-tape, punch-cards, or any other physical medium having patterns of holes, a RAM, a ROM, an EPROM, or any other memory chip or cartridge. Computer-readable media may also be coaxial cables, copper wire, fiber optics, acoustic or electromagnetic waves, capacitive or inductive coupling, etc. As an example, the instructions to be executed by CPU 804 are in the form of one or more software programs and are initially stored in a CD-ROM being interfaced with computer system 800 via bus 824. Computer system 800 loads these instructions in RAMs 808, executes some instructions, and sends some instructions via communication interface 820, a modem, and a telephone line to a network, e.g. network 840, the Internet 852, etc. A remote computer, receiving data through a network cable, executes the received instructions and sends the data to computer system 800 to be stored in storage device 816.

In the foregoing specification, the invention has been described with reference to specific embodiments thereof. However, it will be evident that various modifications and changes may be made thereto without departing from the broader spirit and scope of the invention. Accordingly, the specification and drawings are to be regarded as illustrative rather than as restrictive.

What is claimed is:

1. A method for connecting at least two monitors including a first monitor and a second monitor to a computer system, the method comprising:
connecting the second monitor to the first monitor; and
connecting the first monitor to the computer system;
wherein
in reporting to the computer system,
the second monitor provides second horizontal resolution and second vertical resolution to the first monitor;
the first monitor presents to the computer system as one monitor having total horizontal resolution and total vertical resolution; the total horizontal resolution includes one or a sum of first horizontal resolution and the second horizontal resolution; and the total vertical resolution includes one or a sum of first vertical resolution and the second vertical resolution;
the first horizontal resolution and the first vertical resolution are associated with the first monitor.

2. The method of claim 1 wherein
in receiving from the computer system,
the first monitor receives a total portion including a first portion and a second portion; and
the first monitor displays the first portion and passes on the second portion to the second monitor.

3. The method of claim 2 further comprising the step of connecting a third monitor to the second monitor, wherein
the second monitor passes on a third portion to the third monitor; and
the second portion includes the third portion and a fourth portion displayed by the second monitor.

4. The method of claim 1 further comprising the step of connecting a third monitor to the second monitor, wherein:
the third monitor provides third horizontal resolution and third vertical resolution to the second monitor; and
the second horizontal resolution being a sum of the third horizontal resolution and fourth horizontal resolution associated with the second monitor.

5. The method of claim 1 further comprising the step of connecting a third monitor to the second monitor, wherein:
the third monitor provides third horizontal resolution and third vertical resolution to the second monitor; and
the second vertical resolution being a sum of the third vertical resolution and fourth vertical resolution associated with the second monitor.

6. A computer system, comprising:
a plurality of monitor nodes connected in a daisy chain; the first node being connected to the computer system;
each node of the daisy chain includes one or a plurality of monitors;
the first node receives from the computer system total information to be displayed by monitors in nodes of the daisy chain;
a current node in the daisy chain receives current information including a portion of the current node;
if a node subsequent to the current node in the daisy chain exists, the current information includes a portion of nodes subsequent to the current node in the daisy chain, and the current node passes the portion of nodes subsequent to the current node to the node subsequent to the current node.

7. The computer system of claim 6 wherein the portion of the current node is distributed for display by the one or plurality of monitors included in the current node.

8. A computer system comprising:
a plurality of monitors; and
a plurality of graphic logics forming a daisy chain; each graphic logic supporting at least one monitor; the first graphic logic in the daisy chain being connected to the computer system;
wherein
if a current graphic logic is the first graphic logic in the daisy chain, then the current graphic logic provides information to the computer system;
else if the current graphic logic is a graphic logic other than the first graphic logic in the daisy chain, then the current graphic logic provides the information to a graphic logic preceding the current graphic logic in the daisy chain; and
the provided information includes support capability of the current graphic logic and support capability of graphic logics succeeding to the current graphic logic in the daisy chain.

9. The computer system of claim 8, via the first graphic logic, deals with the plurality of monitors as a single monitor.

10. The computer system of claim 8 further comprising a graphic adapter interfacing with the first graphic logic.

11. The computer system of claim 8 wherein support capability of a graphic logic in the daisy chain includes one or a combination of vertical resolution, horizontal resolution, color depth, and refresh rate of the at least one monitor supported by that graphic logic.

12. The computer system of claim 8 wherein the at least one monitor supported by a graphic logic forms one or a plurality of chains of monitors.

13. The computer system of claim 8 wherein if the current graphic logic is the first graphic logic in the daisy chain then the provided information includes a sum of horizontal resolutions of the plurality of monitors.

14. The computer system of claim 8 wherein if the current graphic logic is the first graphic logic in the daisy chain then the provided information includes a sum of vertical resolutions of the plurality of monitors.

15. The computer system of claim 8 wherein: the plurality of graphic logics include a first pair of graphic logics and a second pair of graphic logics;
a graphic logic in the first pair of graphic logics provides, to its preceding graphic logic, a sum of horizontal resolution of two monitors associated with the first pair of graphic logics; and
a graphic logic in the second pair of graphic logics provides, to its preceding graphic logic, a sum of vertical resolution of two monitors associated with the second pair of graphic logics.
